(19) United States
(12) Patent Application Publication
(10) Pub. No.: US 2005/0109214 A1
(43) Pub. Date: May 26, 2005

(54) Coffee machine

(76) Inventors: Hubert Bruttin, Venthone (CH); Philippe Comte, Saviese (CH)

Correspondence Address: WENDEROTH, LIND & PONACK, L.L.P., 2033 K STREET N. W., SUITE 800, WASHINGTON, DC, 20006-1021, US

(21) Appl. No.: 10/989,661

(22) Filed: Nov. 17, 2004

(30) Foreign Application Priority Data
Nov. 20, 2003 (EP) 03405830.5

(51) Int. Cl. A47J 31/00

(52) U.S. Cl. 99/279

(57) ABSTRACT

The invention concerns a coffee machine with a cylinder piston brewing unit (49) for the brewing of ground coffee as well as a coffee outlet head (1), from which coffee can be dispensed from the cylinder piston unit (49) as well as from a capsule brewing unit (50) for the brewing of capsules with pre-ground coffee installed within the outlet head (1). It is therefore possible to easily and simply make coffee with little mechanical effort as desired or required in the conventional way with the cylinder brewing unit (49) as well as with capsules of pre-ground coffee with an aggregate (50) especially adapted for this purpose.

The invention concerns a coffee machine with a cylinder piston brewing unit for the brewing of ground coffee.

A coffee machine of this type is described in EP-A-761 150. With coffee machines of this type the ground coffee is first filled into a hollow space of the brewing cylinder defined by the pistons of the brewing unit, whereafter the portion of coffee located within the same is compressed between the pistons and boiling water pumped through the compressed coffee cake via one of the pistons, whilst the coffee brewed in this way is conveyed to the coffee outlet through the other piston. Following this the used ground coffee portion is ejected through retracting of the brewing cylinder and the one piston.

Also known are coffee machines where capsules with pre-ground coffee are used. Such capsules can however only be used with coffee machines which work exclusively with these capsules, or with pistons which are filled with ground coffee by hand, or alternatively with capsules of the above type.

It is the purpose of this invention to provide a coffee machine of the type mentioned above which can be used with a reduced mechanical effort as well as more easily, and the operation of which functions more safely and enables universal use.

This task is solved in accordance with the invention in that the coffee machine is equipped with a coffee outlet head from which the coffee can be extracted from the cylinder brewing unit as well as a capsule brewing unit for the brewing of capsules of pre-ground coffee, milk powder, or tea portions installed within the outlet head.

In this way it is possible to operate the coffee machine as desired or required in the conventional way with ground coffee or with pre-prepared coffee capsules without undue effort. For this important components of the coffee machine such as the hot water supply, the pump mechanism, or parts of the cleaning system can be used for both operating methods.

For a simple and effective operation of the machine the invention envisages that the coffee outlet head is equipped with a switching means for the optional extraction of coffee from the cylinder piston brewing unit or the capsule brewing unit.

It is further envisaged according to the invention that the coffee outlet head is equipped with a common coffee outlet for the cylinder piston brewing unit and the capsule brewing unit, whereby the same can be optionally connected with one of the two brewing units via the switching means.

Alternatively the invention envisages that the coffee outlet head incorporates one coffee outlet each for the cylinder piston brewing units and the capsule brewing units, which can be connected via the switching means either with one of the two brewing units or with both brewing units simultaneously.

For the periodic cleaning of the coffee outlet head the invention envisages that the same can be switched from the operating position for the dispensing of brewed coffee into an operating position for the rinsing of the coffee outlet head with hot water or a suitable fluid via the switching means.

For a compact and easily accessible construction the coffee outlet head according to this invention incorporates a housing with a channel block and a tiltable lid with a capsule receiver, whereby the channel block consists of three co-operating block sections with connecting channels to the hot water supply unit as well as the receiving space of the capsule receiver and to the coffee outlet of the coffee outlet head, whereby the rear and the front block section are fixedly installed into the housing, whilst the central block section can be adjusted via the switching means of the coffee outlet head relative to the other two block sections.

For this it is an advantage if the three block sections are located upon a centrally positioned support pin, which is equipped with further connecting channels to the hot water supply unit and the receiving space of the capsule receiver.

In order to avoid a malfunction of the coffee outlet head the invention envisages that the capsule receiver is affixed to a metal support sheet of the lid tiltably attached to the housing, which incorporates arresting hooks that can be engaged into the housing as well as recesses associated with the operating positions of the coffee outlet head, into which a locking pin affixed to the central block section can be inserted.

For this the invention further envisages that the coffee outlet head is equipped with a safety barrier for locking the metal support sheet when the lid is closed.

It is of advantage here if the locking lever is bearingly positioned upon a rotating rod with activating levers at the ends, on which a ratchet segment with a recess for receiving the locking pin is rotation resistantly affixed.

For a simple and easy operation of the machine the invention further envisages that the switching means of the coffee outlet head is equipped with a routing valve controlling the coffee outlet, which co-operates with a control valve for the cylinder piston brewing unit and a control valve for the capsule brewing unit.

The switching means can also appropriately be equipped with a control valve for a water vapour dispensing unit and/or a control valve for a tea dispensing unit.

The invention will now be described in more detail with reference to an embodiment as well as the enclosed drawings, whereby:

FIG. 1 shows a front view of a coffee outlet head for a coffee machine with a cylinder piston brewing unit according to the invention;

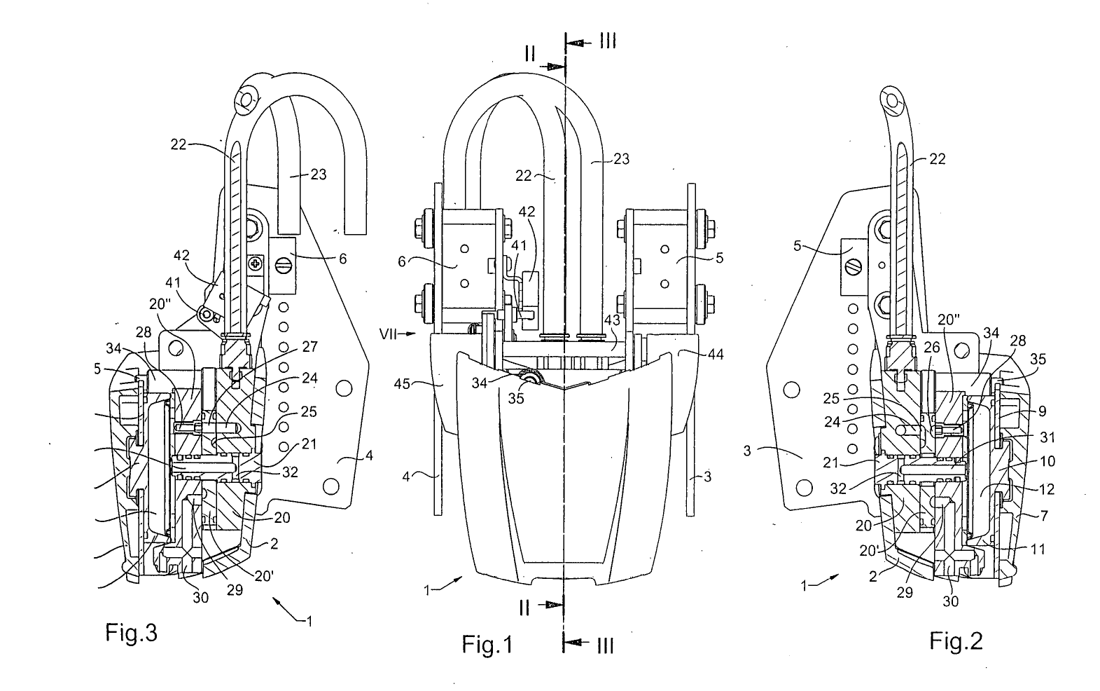

FIG. 2 shows a cross-sectional view along line II-II of FIG. 1 in the coffee dispensing operating position;

FIG. 3 shows a cross-sectional view along line III-III of FIG. 1 in the cleaning position;

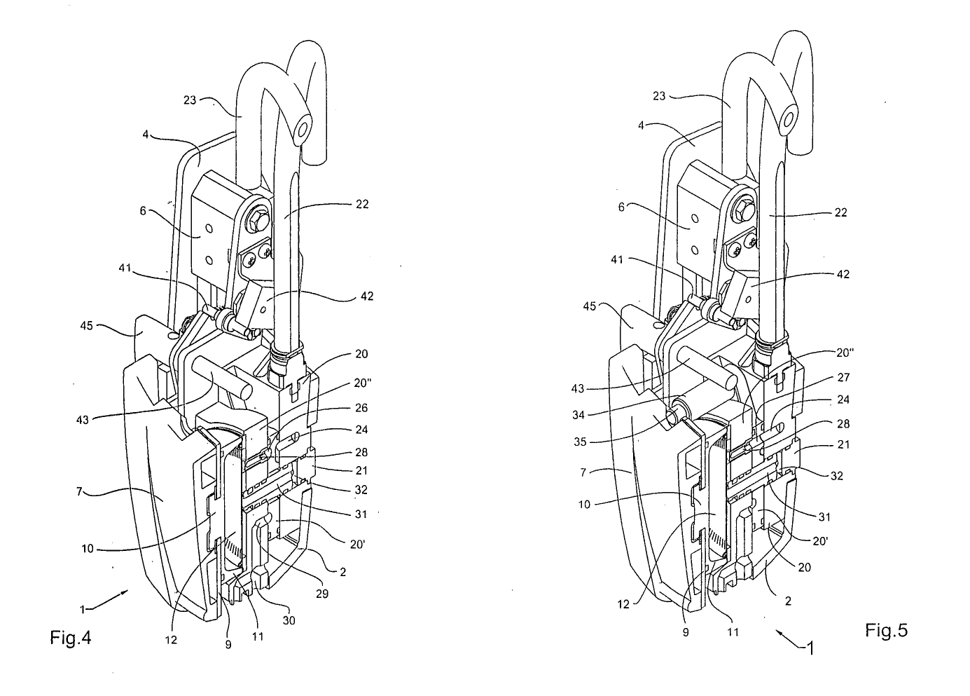

FIG. 4 shows the cross-sectional view of FIG. 3 in the coffee dispensing position and in a perspective view;

FIG. 5 shows the cross-sectional view of FIG. 3 in the cleaning position and in a perspective view;

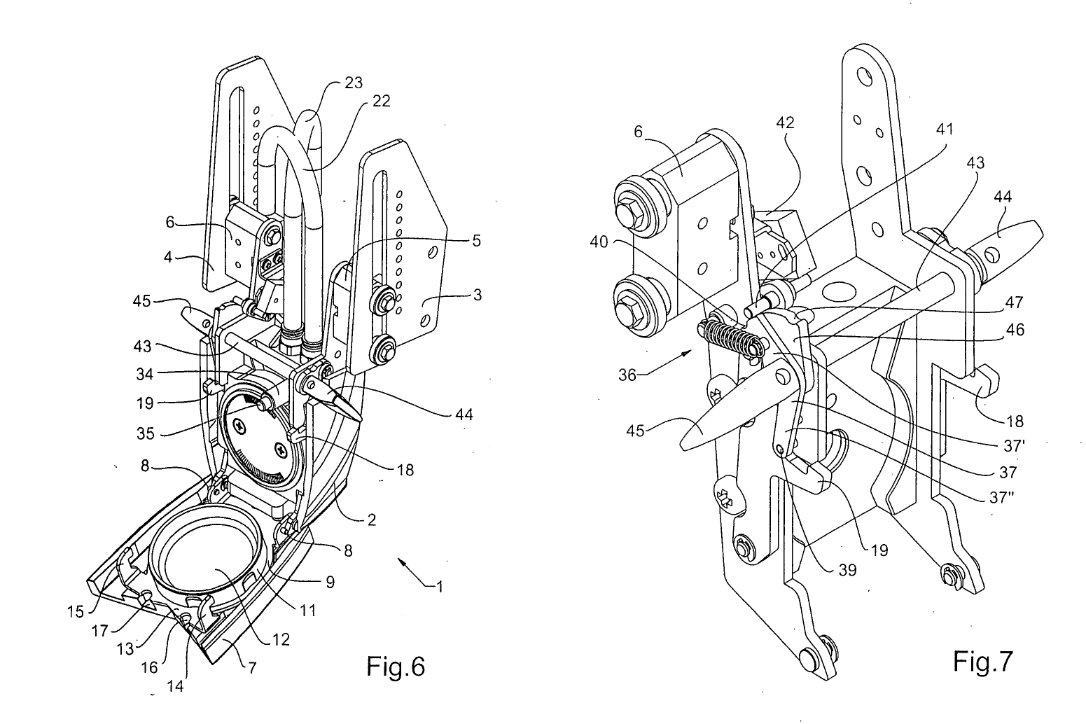

FIG. 6 shows the coffee outlet head of FIG. 1 with open lid in a perspective view;

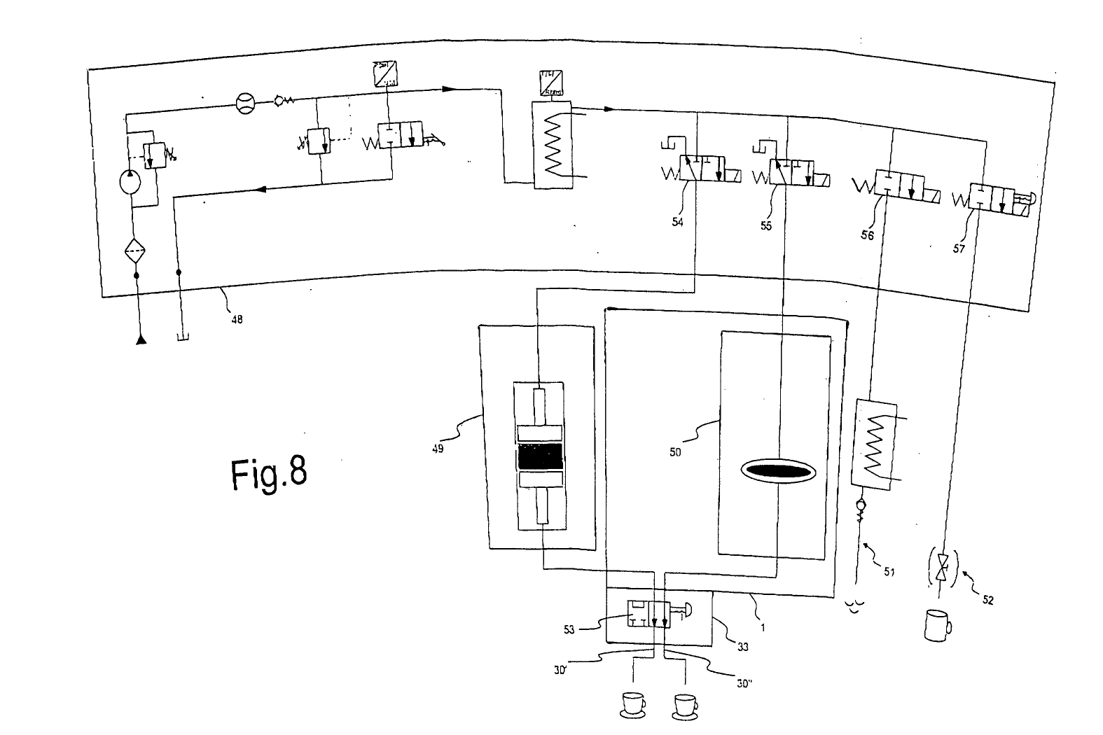

FIG. 7 shows a side view in the direction of arrow VII of FIG. 1 in a perspective, enlarged view; and

FIG. 8 shows the control plan for a coffee machine with the coffee outlet head of FIG. 1 in a schematic view.

The coffee outlet head 1 illustrated in FIGS. 1 to 6 incorporates a housing 2 equipped with two consoles 3, 4 for the affixing of the coffee outlet head 1 onto the coffee machine schematically illustrated in FIG. 8 with internal coffee grinder and a cylinder piston brewing unit for the brewing of ground coffee. The housing 2 is equipped with sledge-shaped holders 5, 6 with which the same is height-adjustably flanged to the consoles 3,4.

The coffee outlet head 1 further incorporates a front-side lid 7 which can be tiled to open the housing 2. Within the lid 7 a metal support sheet 9 tiltable around a bolt 8 is located, onto which a capsule receiver 11 with a capsule receiving space 12 is affixed via a bayonet closure 10.

The metal support sheet 9 further incorporates an edge trim 13 equipped with two arresting hooks 14, 15 and two recesses 16, 17. When the lid 7 is closed these engage the relevant support hooks 18, 19 of the housing 2.

The housing 2 further incorporates a three-section channel block 20, 20′, 20″ with a central support pin 21. At the rear block section 20 a supply line 22 and an outlet line 23 are connected. Both lines are connected via a channel 24 of the rear block section 20 with a part circular groove 25 of the central block section 20′. The latter incorporates a ring channel 26 on the opposite side, which can be connected with the groove 25 via a passage channel 27. The ring channel 26 can further be connected with the channels 28, 29 of the front block section 20″, whereby the channel 28 is connected with the capsule receiving space 12, and the channel 29 with the coffee outlet 30 of the coffee outlet head 1.

The central support pin 21 in turn incorporates an axial channel 31 and a radial channel 32, which are connected with the capsule receiving space 12, i.e. the supply line 22.

The rear and the front block sections 20, 20″ are fixedly installed onto the support pin 21 within the housing 2. The central block section 20′ however is affixed to the support pin 21 via a rotation bearing. It can be rotated via a hydraulic drive not illustrated here between two end positions, which correspond with the operating positions “dispense coffee”, i.e. “cleaning” of the coffee outlet head 1. These end positions are associated with the recesses 16, 17 within the metal support sheet 9 of the lid 7. The control of the hydraulic drive is effected via a switching means 33 with which the coffee outlet head 1 can be positioned in the two operating positions mentioned above.

The central block section 20′ incorporates a front-side support bolt 34 with a locking pin 35, which engages the relevant recess 16, i.e. 17 of the metal support sheet 9 upon reaching the end positions mentioned above. This ensures that the central block section 20′ correctly creates the relevant required connections during co-operation with the block sections 20, 20″ during the activating of the switching means 33.

The coffee outlet head 1 is equipped with a safety barrier 36 illustrated in FIG. 7. This consists of a two-part locking lever 37 whose lever arm 37′ is tensioned by a spring 38, whilst the other lever arm 37″ incorporates a pressure bolt 39 which is pressed against the arresting hook 15 of the metal support sheet 9 during the brewing process, i.e. the pending process or during the cleaning process. In this way it can be avoided that the lid 7 of the coffee outlet head 1 is accidentally opened prior to completion of the relevant work process.

The locking lever 37 further incorporates a recess 40 for receiving of a locking pin 41 at the lever arm 37″, which co-operates with a switch 42 of the switching means 33.

The locking lever 37 is bearingly affixed to a rotating rod 43 with activating levers 44, 45 at its ends, on which a ratchet segment 46 with a recess 47 for receiving of the locking pin 41 is rotation resistantly positioned. During the activating of the safety barrier 36 with the activating levers 44, 45 the ratchet segment 46 is tilted until the locking pin 41 engages the recess 47. Subsequently the locking lever 37 is rotated against the spring 38 until the locking pin 41 also engages the recess 40 of the locking lever 37 and holds the latter in the locking position until the switch 42 once again switches the locking pin 41 according to the operating position of the coffee outlet head 1.

As is clear from FIG. 8 the coffee machine is equipped with a hot water supply unit 48, a cylinder piston brewing unit 49, a capsule brewing unit 50 installed within the coffee outlet head 1, a water vapour dispensing unit 51, as well as a tea dispensing unit 52.

The switching means 33 incorporates a routing valve 53 controlling the coffee outlet 30 of the coffee outlet head 1, which co-operates with a control valve 54 for the cylinder piston brewing unit 49 and a control valve 55 for the capsule brewing unit 50, as well as with a control valve 56 for the water vapour dispensing unit 51 and a control valve 57 for the tea dispensing unit 52. Depending on which operating mode is chosen via the switching means 33 the coffee outlet 30 may dispense coffee from the cylinder piston brewing unit 49 with the relevant switching of the routing valve 53 or coffee, milk, tea or similar from the capsule brewing unit 50.

The coffee outlet head 1 can also be equipped with two separate coffee outlets 30′, 30″ for cylinder piston brewing unit 49 and the capsule brewing unit 50. In this case the routing valve functions in an analogue fashion, i.e. it is adjusted constructively to suit.

It is of course also possible to equip the coffee outlet 30′, 30″ with several branch lines each, for the simultaneous multiple dispensing of coffee from one or the other coffee brewing unit.

As it clear from FIGS. 2 and 4, i.e. 3 and 5, the operating position of the coffee outlet head 1 for the dispensing of coffee is substantially different from the operating position for the cleaning of the outlet head 1 only in that a coffee capsule is inserted into the capsule receiver 11 in the first case, whereafter hot water is supplied via the supply line 22 and the channels 32, 31 of the support pin 21, whilst the brewed coffee flows through the channel 28 of the front block section 20′, the ring channel 26, and the channels 29, 30 of the central block section 20′.

In the second case a cleaning tablet is inserted into the capsule receiver 11, and the hot water supplied via the supply line 22 and the channels 31, 32 is routed from the capsule receiver 12 through the channels 28, 27 and 24 as well as the outlet line 23. The cleaning process can of course also be carried out without a cleaning tablet, i.e. with any suitable cleaning fluid.

1-16. (canceled)

17. Coffee machine with a cylinder piston brewing unit (49) for the brewing of ground coffee, wherein the coffee machine is equipped with a coffee outlet head (1) from which coffee can be dispensed from the cylinder piston brewing means (49) as well as from a capsule brewing unit (50) installed within the coffee outlet head (1), for the brewing of capsules with pre-ground coffee, with milk powder, or with tea portions.

18. Coffee machine according to claim 17, wherein the coffee outlet head (1) is equipped with a switching means (33) for the optional dispensing of coffee from the cylinder piston brewing unit (49) or from the capsule brewing unit (50).

19. Coffee machine according to claim 18, wherein the coffee outlet head (1) is equipped with a common coffee outlet (30) for the cylinder piston brewing unit (49) and the capsule brewing unit (50), whereby the same can be optionally connected with one of the two brewing units (49, i.e. 50) via the switching means (33).

20. Coffee machine according to claim 18, wherein the coffee outlet head (1) incorporates one coffee outlet (30′, i.e. 30″) each for the cylinder piston brewing unit (49) and the capsule brewing unit (50), which can be optionally connected with one of the two brewing units (49, i.e. 50) or with both brewing units simultaneously via the switching means (33).

21. Coffee machine according to claim 18, wherein the coffee outlet head (1) can be switched from the operating position for the dispensing of brewed coffee to an operating position for the flushing of the coffee outlet head (1) with hot water or a relevant fluid via the switching means (33).

22. Coffee machine according to claim 18, wherein the coffee outlet head (1) incorporates a housing (2) with a channel block (20, 20′, 20″) and a tiltable lid (7) with a capsule receiver (11), whereby the channel block (20, 20′, 20″) consists of three co-operating block sections with connecting channels (24 to 29) to the hot water supply unit (48) as well as to the receiving space (12) of the capsule receiver (11) and to the coffee outlet (30) of the coffee outlet head (1), whereby the rear and the front block sections (20, i.e. 20″) are fixedly installed within the housing (2), whilst the central block section (20′) can be adjusted via the switching means (33) of the coffee outlet head (1) in relation to the two other block sections (20, i.e. 20″).

23. Coffee machine according to claim 22, wherein the three block sections (20, 20′, 20″) are installed upon a centrally positioned support pin (21), which is in turn equipped with further connecting channels (31, 32) to the hot water supply unit (48) and the receiving space (12) of the capsule receiver (11).

24. Coffee machine according to claim 22, wherein the connecting channels (24, 28, 29, i.e. 31, 32) of the fixedly installed block sections (20, 20″) and the support pin (21) can be connected with one another via the connecting channels (25, 26, 27) of the central block section (20′) depending on the selected operating position of the coffee outlet head (1).

25. Coffee machine according to claim 22, wherein the central block section (20′) can be adjusted via a hydraulic drive controlled by the switching means (33).

26. Coffee machine according to claim 22, wherein the capsule receiver (11) is affixed to a tiltable metal support sheet (9) of the lid (7) of the housing (2), and in that the same incorporates arresting hooks (14, 15) that can be fixed within the housing (2) as well as recesses (16, 17) corresponding with the operating positions of the coffee outlet head (1), in which a locking pin (35) affixed to the central block section (20′) can be engaged.

27. Coffee machine according to claim 18, wherein the coffee outlet head (1) is equipped with a safety barrier (36) for locking of the metal support sheet (9) when the lid (7) is closed.

28. Coffee machine according to claim 26, wherein the safety barrier (36) is equipped with a two-part locking lever (37) whose one lever arm (37′) is tensioned by a spring (38) whilst the other lever arm (37″) can be pressed against an arresting hook (15) of the metal support sheet (9).

29. Coffee machine according to claim 28, wherein the locking lever (37) incorporates a recess (40) on the other lever arm (37″), for the receiving of a locking pin (41) which co-operates with a switch (42) of the switching means (33).

30. Coffee machine according to claim 29, wherein the locking lever (37) is bearingly positioned upon a rotating rod (43) with activating levers (44, 45) at its ends, on which a ratchet segment (46) with a recess (47) is rotation-resistantly affixed for the receiving of the locking pin (41).

31. Coffee machine according to claim 18, wherein the switching means (33) is equipped with a routing valve (53) that controls the coffee outlet (30), and in that the same co-operates with a control valve (54) for the cylinder piston brewing unit (49) and a control valve (53) for the capsule brewing unit (50).

32. Coffee machine according to claim 31, wherein the switching means (33) is further equipped with a control valve (56) for a water vapour dispensing unit (51) and/or a control valve (57) for a tea dispensing unit (52).
